(19) United States
(12) Patent Application Publication
(10) Pub. No.: US 2017/0308609 A1
(43) Pub. Date: Oct. 26, 2017

(54) MULTI-RESULT RANKING EXPLORATION

(71) Applicant: MICROSOFT TECHNOLOGY LICENSING, LLC, Redmond, WA (US)

(72) Inventors: PAVEL Y. BERKHIN, SUNNYVALE, CA (US); DRAGOMIR D. YANKOV, SUNNYVALE, CA (US); LIHONG LI, REDMOND, WA (US)

(21) Appl. No.: 15/135,163

(22) Filed: Apr. 21, 2016

(51) Int. Cl. G06F 17/30

(52) U.S. Cl. CPC G06F 17/30864; G06F 17/3053; G06F 17/30589

(57) ABSTRACT

Aspects of the technology described herein can improve the efficiency of a multi-result set ranking model by selecting a better exploration strategy. The technology described herein can improve the use of the result set opportunities by running offline simulations of different exploration policies to compare the different exploration policies. A better exploration policy for a given ranking model can then be implemented. In addition to allocating an efficient amount of result set opportunities to exploration, the selection of exploration results can help reduce performance drop during exploration. Thus, the technology described herein can provide valuable exploration data to improve ranking performance in the long run, and at the same time increase performance while exploration lasts.

### BACKGROUND

Use of “multi-result” ranking systems, i.e., systems which rank a number of candidate results and present the top N results to the user, are widespread. Examples of such systems are Web search, query auto-completion, news recommendation, etc. “Multi-result” is in contrast to “single-result” ranking systems that also internally utilize ranking mechanisms, but display only one result to the user.

One challenge with improving ranking systems in general is their counterfactual nature. Existing technology cannot directly answer questions of the sort “Given a query, what would have happened if the search engine had shown a different set of results?” as this is counter to the fact. The fact is that the search engine showed whatever results the current production model used for ranking considered best. Learning new models from such data is biased and limited by the deployed ranking model, resulting in misleading results and inferior ranking models.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein can improve the efficiency of a multi-result set ranking model by evaluating the effectiveness of different exploration strategies. The technology described herein allows different explore-exploit policies to be evaluated offline to allow a better explore-exploit policy to be implemented online. The selected EE policy can improve precision in a multi-result ranking system, such as Web search, query auto-completion, and news recommendation. Typically, a ranking model is trained and then put into production to present ranked result sets to a user. A portion of the result sets may include exploration result sets that are used to update or retrain the ranking system. The exploration result sets include one or more results that would not otherwise have appeared if the rankings for the results provided by the ranking model were followed. For example, the sixth ranked result could replace the third ranked result for the purpose of exploration. The user's selection or non-selection of the exploration data (i.e., the sixth result) can be used to retrain the ranking system.

Each presentation of results to a user, described herein as a result set opportunity, can be thought of as a resource. Using too many of the result set opportunities for exploration can reduce the system efficiency by presenting results the user does not select. The technology described herein can evaluate the use of the result set opportunities by running offline simulations of different exploration policies to compare the different exploration policies. The desired exploration policy for a given ranking model can then be implemented. Improving the percentage of result set opportunities allocated to exploration and improving the selection of exploration result sets (results that would not normally be presented) can minimize loss during exploration.

In addition to providing information that can be used to select an amount of result set opportunities allocated to exploration, the selection of exploration results can help reduce inefficiency during exploration. In an aspect, the exploration policy selected by the technology described herein can cause a lift in performance (e.g., CTR, revenue, user interaction metric), during exploration, rather than a loss. Thus, the technology described herein can provide valuable exploration data to improve ranking performance in the long run, and at the same time increase performance while exploration lasts.

### BRIEF DESCRIPTION OF THE DRAWINGS

Aspects of the technology described in the present application are described in detail below with reference to the attached drawing figures, wherein:

FIG. 1 is a block diagram of an exemplary computing environment suitable for implementing aspects of the technology described herein;

FIG. 2 is a diagram depicting an exemplary computing environment including an offline simulator for exploration policies, in accordance with an aspect of the technology described herein;

FIG. 3 is a diagram depicting an exemplary multi-result set, in accordance with an aspect of the technology described herein;

FIG. 4 is a diagram depicting a method of simulating and comparing exploration policies used to evaluate a multi-result set ranking model, in accordance with an aspect of the technology described herein;

FIG. 5 is a diagram depicting a method of simulating and comparing exploration policies used to evaluate a multi-result set ranking model, in accordance with an aspect of the technology described herein;

FIG. 6 is a diagram depicting a method of simulating and comparing exploration policies used to evaluate a multi-result set ranking model, in accordance with an aspect of the technology described herein; and

FIG. 7 is a block diagram of an exemplary computing environment suitable for implementing aspects of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein can improve the efficiency of a multi-result set ranking model by selecting an improved exploration strategy. The technology described herein sets improved online explore-exploit policies to improve precision in a multi-result ranking system, such as Web search, query auto-completion, and news recommendation. Typically, a ranking model is trained and then put into production to present ranked result sets to a user. A portion of the result sets may include exploration datasets that are used to update or retrain the ranking system. The exploration datasets include results that would not otherwise have appeared as a result. For example, the sixth ranked result could replace the third ranked result for the purpose of exploration. The user's selection or non-selection of the exploration data can be used to retrain the ranking system. Poorly selected explore-exploit (EE) polices can cause inefficient deployment of computer resources, cause broad user dissatisfaction resulting in multiple searches, or collect exploration data which is altogether useless in improving the ranking model.

Each presentation of results to a user, described herein as a result set opportunity, can be thought of as a resource. Using too many of the result set opportunities for exploration can reduce the system efficiency by presenting results the user does not select. The technology described herein can make efficient use of the result set opportunities by running offline simulations of different exploration policies to allow comparison of the different exploration policies. The better exploration policy for a given ranking model can then be implemented.

Exploration substitutes a certain amount of results produced by a production ranking system with lower ranked results (exploration results) that otherwise would not have been presented. The user interaction with the exploration results can be used as feedback to retrain the ranking model, thereby improving the model's effectiveness.

As used herein, the phrase “production result set” means the top ranked results determined by a production ranking model (e.g., L₂ ranking model 224) presented in the order of rank determined by the production model. The individual results within the production result set can be described as a production result.

As used herein, the phrase “exploration result set” means a result set that includes at least one exploration result. An exploration result is a result that is not one of the top ranked results that would be included in the production result set. The exploration result set can include a combination of production results and exploration results.

The model performance is typically described herein in terms of click-through rate, but other performance metrics can be used. The performance metric can be click-through rate, a user interaction metric based on more than just clicks (e.g. dwell time, hovers, gaze detection), and a revenue measure. The revenue measure can be calculated when the multi-result ranking model returns ads or other objects that can generate revenue when displayed, clicked, or when conversion occurs (e.g., the user makes a purchase or signs up on a linked website). For the sake of simplicity, the detailed description will mostly describe the performance in terms of click-through rate, but other performance measures could be substituted without deviation from the scope of the technology.

Exploration is used to improve the ranking model in the long run, but can be costly in the short term. During exploration, the system may suffer large losses, create user dissatisfaction, or collect exploration data which does not help improve ranking quality. The losses can result from a loss of clicks caused by presenting an exploration result set that is possibly inferior to the production result set.

In addition to allocating a better amount of result set opportunities to exploration, the improved selection of exploration results can help reduce inefficiency during exploration. In an aspect, the correct exploration policy generated by the technology described herein can cause a lift in performance, for example, as measured by click-through rate (CTR), during exploration, rather than a loss. Thus, the technology described herein can provide valuable exploration data to improve ranking performance in the long run, and at the same time increase performance while exploration lasts.

The technology described herein can simulate different exploration policies using records of user interaction with production result sets. In an aspect, the simulation attempts to determine what would have happened had less than the full result set been shown to the user. For example, if the actual result set had five results displayed to the user, then the simulation could assume that just the top three results were shown to the user. The bottom two results can be used to test the exploration policy by replacing one of the top three results with one of the bottom two according to the simulated exploration policy.

The simulated baseline click-through rate (CTR) from showing just the top three results can be compared to the simulated CTR of the exploration results to determine the cost (if CTR decreases) or benefit (if CTR increases) of the exploration process. The improvements to the model can be simulated by retraining a ranking model using the baseline results to generate a baseline model and then retraining the ranking model on the simulated exploration results. The baseline model and exploration model can be tested on an additional set of user data to determine which produced better results as measured by CTR.

Having briefly described an overview of aspects of the technology described herein, an exemplary operating environment suitable for use in implementing the technology is described below.

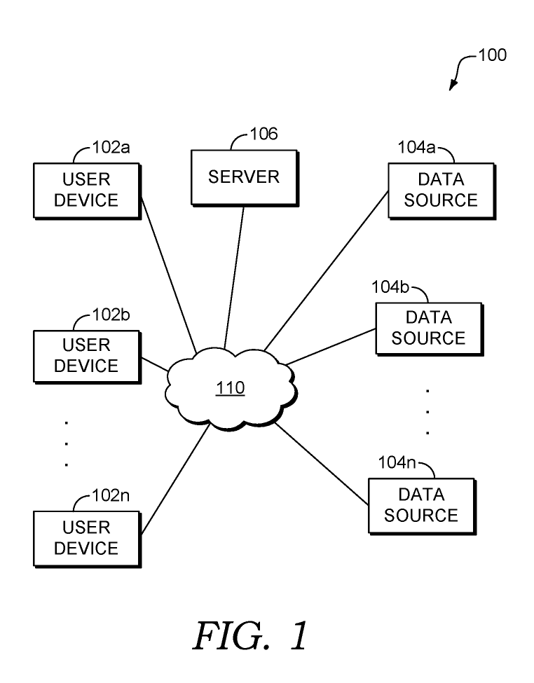

Turning now to FIG. 1, a block diagram is provided showing an example multi-result ranking environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

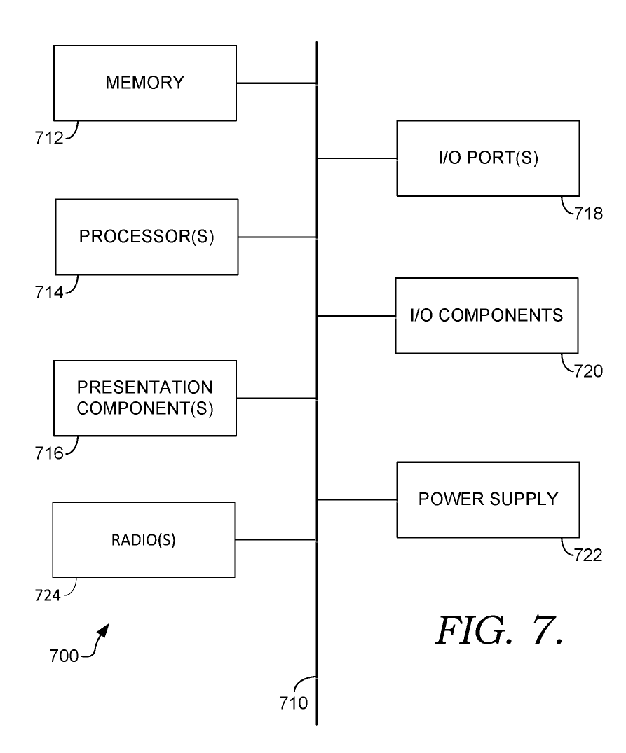

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 700 described in connection to FIG. 7, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can provide system input that is used to generate result sets, receive result sets, and then interact with the result sets. The result sets can be production result sets or exploration result sets. The system input can be a query, partial query, text, and such. The system input is communicated over network 110.

Server 106 can comprise server-side software designed to work in conjunction with client-side software on user devices 102a and 102b through 102n so as to implement any combination of the features and functionalities discussed in the present disclosure. For example, the server 106 may provide ranked results, for example, as generated by ranking system 210. Among other tasks, the server 106 can generate production results and exploration results, update/retrain a ranking model, and simulate different exploration policies. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 7 herein. By way of example and not limitation, a user device may be embodied as a personal computer (PC), a laptop computer, a mobile or mobile device, a smartphone, a tablet computer, a smart watch, a wearable computer, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

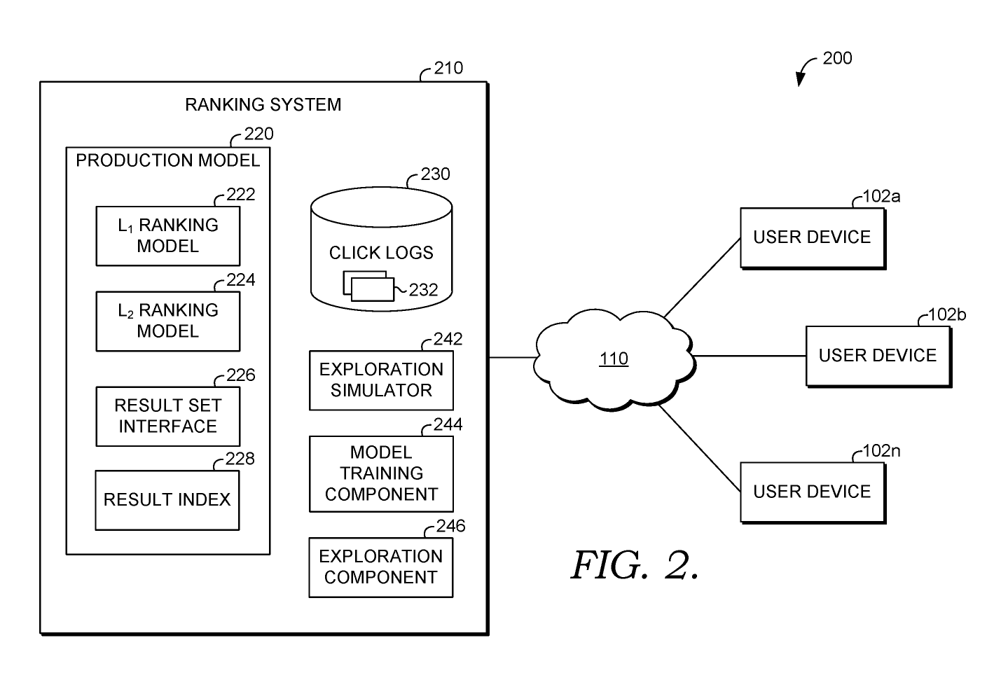

Data sources 104a and 104b through 104n may comprise data sources and/or data systems, which are configured to make data available to any of the various constituents of operating environment 100, or system 200 described in connection to FIG. 2. (For example, in one aspect, one or more data sources 104a through 104n provide (or make available for accessing) webpage information, user information, or other information to the ranking system 210 of FIG. 2.) Data sources 104a and 104b through 104n may be discrete from user devices 102a and 102b through 102n and server 106 or may be incorporated and/or integrated into at least one of those components. The data sources 104a through 104n can comprise a knowledge base that stores information that may be responsive to a query.

Operating environment 100 can be utilized to implement one or more of the components of system 200, described in FIG. 2, including components for collecting user data, receiving queries and other input, generating ranked results, generating production and exploration result sets, simulating exploration policies, and implementing exploration policies.

In one aspect, the functions performed by components of system 200 are associated with one or more applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some aspects functionality of these components can be shared or distributed across other components.

Referring now to FIG. 2, with FIG. 1, a block diagram is provided showing aspects of an example computing system architecture suitable for implementing an aspect of the technology described herein and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including ranking system 210 (including its components 220, 222, 224, 226, 228, 230, 232, 242, 244, and 246), with user device 102a, user device 102b, and user device 102n. Ranking system 210 may be embodied as a set of compiled computer instructions or functions, program modules, computer software services, or an arrangement of processes carried out on one or more computer systems, such as computing device 700 described in connection to FIG. 7, for example.

The technology described herein can integrate an exploration component 246 into the production system to help break the dependence on an already deployed model. Exploration allows for occasionally randomizing the results presented to the user by overriding some of the top choices of the deployed model and replacing them with potentially inferior results (exploration results). This leads to collecting certain random results generated with small probabilities. Such randomization allows the system to collect data that can reliably reveal, in a probabilistic way, what users would have done if the ranking results were changed. When the model training component 244 is training subsequent ranking models, each result in the randomized data can be assigned a weight that is inversely proportional to the probability with which it was chosen in the exploration phase. The exploration result data can be used by model training component 244 to retrain the model. The goal is for the exploration result data to improve model performance more than just using the production result sets to retrain the model. Model performance can be measured in terms to click-through rate.

Exploration usually allows better models to be learned. However, adopting exploration in a production system prompts a set of essential questions: which explore-exploit (EE) policy is most suitable for the system; what would be the actual cost of running EE; and how to best use the exploration data to train improved models and what improvements are to be expected?

The technology described herein uses an offline exploration simulator 242 which allows “replaying” query logs to answer counterfactual questions and select the EE policy that better allocates result set opportunities to exploration. The exploration simulator 242 can be used to answer the above exploration questions, allowing different EE policies to be compared prior to conducting actual exploration in the online system. Poorly selected EE polices can cause inefficient deployment of computer resources, cause broad user dissatisfaction resulting in multiple searches, or collect exploration data which is altogether useless in improving the ranking model.

In one aspect, the technology described herein uses an offline exploration simulator 242 to evaluate Thompson sampling at different rates to provide information about the effectiveness of different exploration rates. Thompson sampling is an EE method which effectively trades exploration and exploitation. Aspects of the technology are not limited to use with Thompson sampling, and other sampling methods can be simulated. The offline exploration simulator 242 can simulate different exploration policies using records of user interaction with previously presented production results 232, which can be retrieved from click log data store 230.

For multi-result ranking systems, there exist different ways of instantiating Thompson sampling, each having a different semantic interpretation. Some of the implementations correct for bias (calibration problems) in the ranking model scores while others correct for position bias in the results. Naturally, employing different strategies leads to different costs and to different model improvements. The costs can include the “price” to be paid for exploring lower ranked results as measured in decreased performance (e.g., CTR) during testing. The exploration simulator 242 described herein can evaluate the cost and benefit of each EE policy simulated.

Since EE can promote lower ranked results for exploration, it is commonly presumed that production systems adopting EE always sustain a drop in key metrics like click-through rate during the period of exploration. By analyzing Thompson sampling policies through the exploration simulator 242, however, it is possible to produce a lift in CTR during exploration (exploration CTR) in some models depending on the exploration policy selected. In other words, the benefit of using EE strategies like Thompson sampling is twofold: (1) the system collects randomized data that are valuable for training a better model in the future; and (2) the system performance can even improve online metrics like CTR while exploration continues.

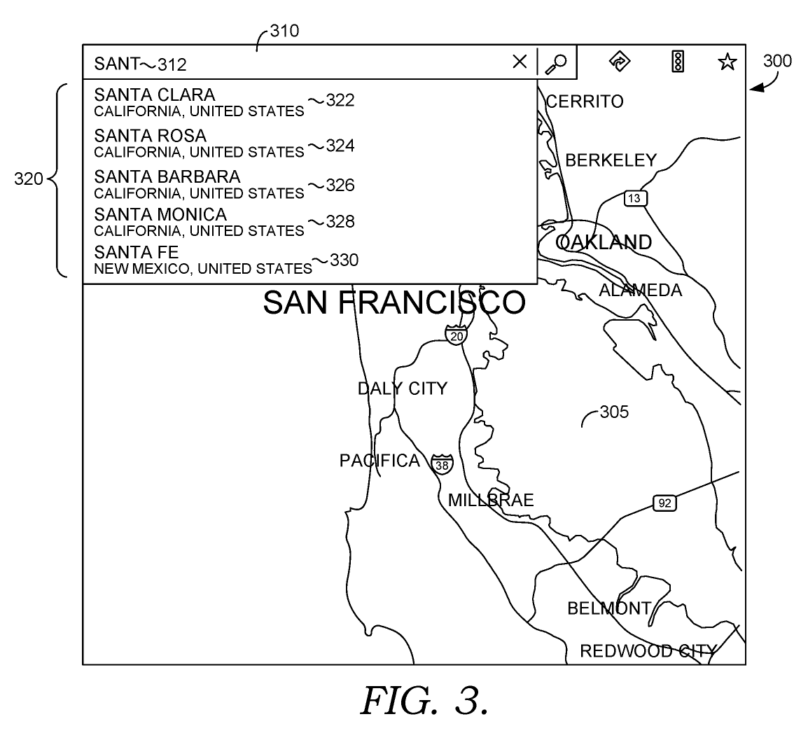

The auto-completion service of FIG. 3 shows data that is used in the example simulations explained subsequently. When users start typing a query “Sant” 312 into the query box 310 on a map page 300, they are presented with up to N=5 relevant geo entities as suggestions. In this case, the suggestions include “Santa Clara” 322, “Santa Rosa” 324, “Santa Barbara” 236, “Santa Monica” 328, and “Santa Fe” 330. While five suggestions are shown in this example, aspects of the technology are not limited to the use of five suggestions. For example, a search result page could have 10 to 15 search results. As can be seen, each suggestion starts with the partial query. Other data, such as the user's current location, can be used to generate and rank the suggestions. If users click on one of the suggestions, then the system has met their intent; if they do not, the natural question to ask is “Could the auto-complete system have shown a different set of results which would get a click?” As mentioned previously, the question is counterfactual and cannot be answered easily as it requires showing a different set of suggestions on exactly the same context. The exploration simulator 242 provides a simulated answer to such counterfactual questions.

Before detailing the exploration simulator 242, a brief explanation of the production model 220, which generates the suggestions, is provided. The production model 220 is a large-scale ranking system that provides a multi-result result set. The results could be search results, auto-complete, or some other type of result. For the sake of example, the production model 220 will be described herein as providing the auto-complete suggestions shown in FIG. 3. The suggestions can be generated by matching an input, such as a query or partial query, against the result index 228.

The content of the result index 228 will vary with application, but in this example, the result index will include a plurality of geo entities, since it is tailored to the map application. An index of auto-complete results for a general purpose search engine could comprise popular search queries submitted by other users. As an initial step, the production model 220 can generate a raw result set that includes any geo entity that matches the query. For example, the raw result sets include any terms within the result index 228 that matches the partial query “Sant” 312.

For all matched entities in the raw result set, a first layer of ranking, L₁ ranker 222, is applied. The goal of the L₁ ranker is to ensure very high recall and prune the matched candidates to a more manageable set of, say, a few hundred results. A second layer, L₂ ranker 224, is then applied which reorders the L₁ results in a way to ensure high precision. Aspects of the technology described herein are not limited to the three stage model shown. There could be more layers with some specialized functionality, but overall, these three stages cover three important aspects: matching, recall, and precision. The result set interface 226 outputs the result set to a requesting application. In an aspect, the result set interface 226 can receive a user input that is used to generate the result set.

The technology described herein could be used to simulate exploration policies for both the L₁ ranker 222 and the L₂ ranker 224 and select a better exploration policy. However, the following examples will focus on methodologies for improving the L₂ ranking 224, namely, increasing precision of the system. The L₂ ranker 224 can comprise a machine learned model using a learning-to-rank approach. Other types of models are possible.

The click log data store 230 includes a record of production results 232 presented to a user by the production model 220. The data store 230 can include millions of records. The result set can also include a record of user interactions with the result sets, such as the selection of a result (e.g., a click) and other interactions with the result (e.g., dwell time, gaze detection, hovering). The click log data store 230 can also include conversion information or other revenue related data (e.g., cost-per click, cost-per view, cost-per conversion) for certain types of results. The revenue information can be used to calculate revenue metrics that can serve as a performance metric. Table 1 shows information that can be logged by a multi-result ranking system for a query.

TABLE 1
Original system: example logs for one query.

| Position (i) | Label (y) | Results (r) | Rank score (s) |
|---|---|---|---|
| i = 1 | 0 | Suggestion 1 | s₁ = 0.95 |
| i = 2 | 0 | Suggestion 2 | s₂ = 0.90 |
| i = 3 | 1 | Suggestion 3 | s₃ = 0.60 |
| i = 4 | 0 | Suggestion 4 | s₄ = 0.45 |
| i = 5 | 0 | Suggestion 5 | s₅ = 0.40 |

Suppose that the L₁ ranking model 222 extracted M≧N relevant results, which were then re-ranked by the L₂ ranking model 224 to produce the top N=5 suggestions from Table 1. For at least a portion of the queries, the suggestions from the table and the user interactions with the suggestions are logged by the production system in the click log data store 230.

The first column in the table shows the ranking position of the suggested result. The label column (y) reflects the observed clicks. The value in the label column is 1 if the result was clicked and 0 otherwise. The result column (r) contains some context about the result that was suggested, part of which is only displayed to the user and the rest is used to extract features to train the ranking model. The last column shows the score (s), which the L₂ ranking model 224 has assigned to the results. The score can be a relevance or confidence score that the result is responsive to the partial query. Each result set can also be associated with a time and date when the result set was presented to a user.

The exploration component 246 implements an exploration process in the online environment. The technology described herein attempts to determine the best exploration policy for the exploration component 246 to use. In an example exploration policy, the exploration component 246 is allowed to replace only suggestions appearing at position i=N. In other words, the exploration component 246 can replace the lowest ranked result to be shown with an exploration result. This is to avoid large user dissatisfaction by displaying potentially bad results as top suggestions. For exploration, in addition to the candidate at position i=N, the exploration policy can be limited to selection of an exploration result from among the candidates which the L₁ ranking model 222 returns and the L₂ ranking model 224 ranks at positions i=N+1; : : : ; i=N+t≦M, for some relatively small t. By doing so, the policy does not explore results that are very low down the ranking list of L₂ as they are probably not very relevant. Requiring that a candidate for exploration meets some minimum threshold for its ranking score is also a good idea. In some implementations, only results with above a threshold relevance score are included in the result set. This may result in less than N results in some result sets. If for a query there are less than N=5 candidates in a result set, then no exploration takes place for it under the policy described above.

Running the above EE process directly in the production environment can lead to costly consequences: it may start displaying inadequate results which can cause the system to sustain significant loss in click-through rate in a very short time. Furthermore, it is unclear whether the exploration will help collect training examples that will lead to improving the quality of the ranking model.

The exploration simulator 242 can simulate variations on the above online process in an offline system that closely approximates the online implementation. The offline system mimics a scaled down version of the production system. Specifically, the offline simulation can assume that auto-completion system displays k<N results to the user instead of N=5. Again, to replicate the online EE process described above, different policies evaluated in the offline system will be allowed to show on its last position (i.e., on position k in the simulation) any of the results from positions i=k, . . . , N. In other words, the simulation is limited to exploration results that were actually shown to users as production results. In this way, the simulation can determine whether the user selected the exploration result.

To understand the offline process better, two concrete instantiations of the simulation environment which use the logged results from Table 1 are explained below. In the first instantiation, k=2. It means that the offline system displays to the user two suggestions, as seen in Table 2. Position i=2 (in grey) is used for exploration. The result to be displayed will be selected among the candidates at position i=2, . . . , i=5. Using only the production system (non-exploration) would display in our simulated environment “Suggestion 1” and “Suggestion 2,” and a click would not be observed because a click as the label in the logs for both position i=1 and i=2 is zero.

In the second instantiation, k=3; that is, the offline system is assumed to display three suggestions. Position i=3 is used for exploration and the candidates for it are the results from the original logs at positions i=3, 4, or 5. Showing the result from either position 4 or 5 is exploration. This setting is depicted in Table 3.

As mentioned, Table 3 is for an offline system with k=3 suggestions. Logs for one query are derived from the logs from Table 1. Position i=3 (in blue) is used for exploration. Suppose we use k=2.

Now suppose the simulator 242 simulates two EE policies, π₁ and π₂, each selecting a different result to display at position i=2. For example, π₁ can select to preserve the result at position i=2 (“Suggestion 2”), while π₂ can select to display instead the result at position i=3 (“Suggestion 3”). Now we can ask the counterfactual, with respect to the simulated system, question, “What would have happened had we applied either of the two policies?” The answer is with π₂ we would have observed a click, which we know from the original system logs (Table 1) and with π₁ we would not have. If this is the only exploration which we perform, the information obtained with π₂ would be more valuable and would probably lead to training a better new ranking model. Note also that applying π₂ would actually lead to a higher CTR than simply using the production system. This gives an intuitive idea of why CTR can increase during exploration.

The simulation effectively repeats this process thousands or millions of times with different result sets. In one aspect, the iterations in the simulation can be varied to determine the amount of exploration that is most beneficial. In general, more exploration is usually beneficial, but the simulation can identify the point of diminishing returns. For example, the simulation could determine that allocating 5% of result set opportunities to exploration generates 95% of the possible improved model performance as allocating 25% of result set opportunities to exploration.

It should be noted that the simulation environment effectively assumes the same label for an item when it is moved to position k from another, lower position k′>k. Due to position bias, CTR of an item tends to be smaller if the item is displayed in a lower position. In other words, users tend to select the first results shown more than subsequent results, all else being equal. Therefore, the present simulation environment has a one-sided bias, favoring the production baseline that collects the data. While the bias makes the offline simulation results less accurate, its one-sided nature implies the results are conservative: if a new policy is shown to have a higher offline CTR in the simulation environment than the production baseline, its online CTR can only be higher in expectation.

As mentioned, the exploration simulator can simulate Thompson sampling. Several instantiations of Thompson sampling are possible and each simulation can change one or more variables. The underlying principle of Thompson sampling for exploration trade off is probability matching. At every step, based on prior knowledge and clicked data observed so far, the algorithm computes the posterior probability that each item is optimal, and then selects items randomly according to these posterior probabilities. When the system is uncertain about which item is optimal, the posterior distribution is “flat,” and the system explores more aggressively. As data accumulate, the system eventually gathers enough information to confidently infer which item is optimal, resulting in a “peaked” posterior distribution that has most of the probability mass on the most promising item. Thompson sampling thus provides an elegant approach to exploration and can often be implemented very efficiently.

There are multiple methods to implement Thompson sampling for multi-result ranking problems and these different models can be simulated. The different methods have different interpretations and lead to different results. Second, if the “right” implementation for the problem at hand is selected, then Thompson sampling can refine the ranking model CTR estimates to yield better ranking results. The method then essentially works as an online learner, improving the CTR of the underlying model by identifying segments where the model is unreliable and overriding its choice with a better one.

The exploration simulator 242 can simulate exploration polices with different sampling intervals or buckets. Each interval definition is characterized by: (1) how it defines the buckets; and (2) what probability estimate the bucket definition is semantically representing.

A naive approach to defining a bucket is to define every distinct query-item pair as a bucket, and then in each iteration run Thompson sampling on buckets that are associated with the query in that iteration. Such an approach may not scale when data is sparse or when there are many tail queries with low frequency.

### Sampling Over Positions Policy

Sampling over positions policy defines buckets over the ranking positions used for drawing exploration candidates. This is probably the most straightforward implementation of Thompson sampling.

The Bucket definition: There are n=N−k+1 buckets each corresponding to one of the candidate positions iε{k, k+1; . . . ; N}. All of them can be selected in each iteration. For instance, if we have instantiation as per Table 3, the sampling over positions policy would have three buckets, n=3, for positions iε2 {3, 4, 5}, which are the positions of the candidates for exploration.

Probability Estimate:

P(click|i, k). In this implementation, Thompson sampling estimates the probability of click given that a result from position i is shown on position k. This implementation allows for correction in the estimate of CTR per position. The approach also allows for correcting position bias. Indeed, results which are clicked simply because of their position may impact the ranking model, and during exploration, higher ranked results can be replaced with lower ranked results eliminating the effect of position on the system. This makes the sampling over positions policy approach especially valuable in systems with pronounced position bias.

### Sampling Over Scores Policy

In this implementation, we define the buckets over the scores of the ranking model. Each bucket covers a particular score range. For simplicity, the score interval [0; 1] can be divided into one hundred equal subintervals, one per each percentage point: [0; 0.01]; [0.01; 0.02]; . . . ; [0.99; 1]. Aspects are not limited to one hundred subintervals. A good division can be identified empirically for the system being simulated, for instance, through cross-validation.

As a general rule, the number of intervals should be relatively granular while still making sense and allowing each bucket to be visited by the algorithm and its parameters to be updated. If, for instance, the ranking model which the system uses outputs only three scores (say 0, 0.5 and 1), then it makes sense to have only three score buckets. In the present example shown in Tables 1 and 2, the L₂ model is trained on a fairly large and diverse dataset, which leads to observing a large number of score values covering the entire [0; 1] interval. Therefore, using only 10 intervals is too coarse and produces worse results. On the other extreme, using too many buckets, say more than 1000, leads to sparseness with only a subset of all buckets being visited and updated regularly, which as mentioned does not improve the results further.

Bucket Definition:

There are n=100 buckets, one per score interval P₁=[0; 0.01]; . . . ; P₁₀₀=[0.99; 1]. In each iteration only a small subset of these are active. In the example from Table 3, only the following three buckets are active P_{c1}=P₆₁=[0.60; 0.61], P_{c2}=P₄₆=[0.45; 0.46], and P_{c3}=P₄₁=[0.40; 0.41]. Suppose after drawing from their respective Beta distributions, the simulator 242 determines that m=61, i.e., the first of the three candidates which turns out to result in a click should be shown. In this case, the positive outcome parameter for the corresponding Beta is updated.

Probability Estimate:

P(click|s, k). In this implementation, Thompson sampling estimates the probability of click given a ranking score s for a result when shown at position k. In general, if the simulator runs a calibration procedure, then the scores are likely to be close to the true posterior click probabilities for the results, but this is only true if the scores are evaluated agnostic of position. With respect to position i=k, they may not be calibrated. We can think of Thompson sampling as a procedure for calibrating the scores from the explored buckets to closely match the CTR estimate with respect to position i=k.

### Sampling Over Scores and Positions Policy

This is a combination of the above two implementations. Again, for simplicity, the score interval is divided into one hundred equal parts: [0; 0.01]; [0.01; 0.02]; . . . ; [0.99; 1]. This, however, is done for each candidate position i=k, . . . , i=N. That is, the bucket definition is (N−k+1)×100 buckets. For more compact notation, let us assume that bucket P_{q}ⁱ covers entities with score in the interval (s, s+0.01) when they appear on position i (here q=[100 s]+1). In the example from Table 3, we have n=300 buckets and for the specific iteration the three buckets to perform exploration from are P₆₁³, P₄₆⁴, and P₄₁⁵.

Probability Estimate:

P(click|s, i, k). In this implementation, Thompson sampling estimates the probability of click given a ranking score s and original position i for a result when it is shown at position k instead. This differs from the previous case as in its estimate it tries to take into account the position bias, if any, associated with clicks.

The above examples are not all the ways the buckets that could be defined. Depending on the concrete system to be simulated, there may be others that are more suitable and lead to even better results.

The last two policies based on model scores are very suitable for multi-result ranking systems. With sampling over scores, better model improvement can be observed once the models are retrained with exploration data, while sampling over scores and positions leads to better CTR during the period of exploration. The reason why these policies are effective lies in the dynamic nature of ranking. It is very susceptible to changing conditions. Though click prediction models are calibrated on training data, the scores may quickly become biased. Specifically for maps search, there are constant temporal effects such as geo-political events in different parts of the world, news about disasters or other unexpected events in different places, seasonal events for example about periodic sports tournaments, etc. There is also the impact of confounders—factors that impact the relevance of results but are hard to account for, and hence model. For example, this may be a mentioning of a place on social media which instantly picks up interest, or showing a picture of a place on a heavily visited webpage, such as the front search page, which leads to sudden increase in queries targeting this place. Both changing conditions and presence of confounders often lead to change in relevance of the same result within the same query context over time. The score-based Thompson sampling policies can account for that by constantly re-computing the click probability estimates discussed above and re-ranking results accordingly.

The model training component 244 retrains the ranking model based on user data. The user data includes interaction with production results and interaction with exploration results. The retraining method can vary according to the model type. In one aspect, the exploration data is weighted as part of the retraining. The model training component 244 can use one of at least two different schemes for weighting of examples, collected through exploration, during training new ranking models. Once an EE procedure is in place, a natural question to ask is how to best use the exploration data to train improved models. Note that the exploration data is not collected by a uniform random policy, thus some items have greater presence than others in the data. Reweighting of exploration data is important to remove such sampling bias.

In one aspect, propensity-based weights are used to weight the exploration results when retraining a model. In training new rankers, it is a common practice to reweight examples selected through exploration inversely proportional to the probability of displaying them to the user. The probability of selecting an example for exploration is called propensity score. Such a scheme, often referred to as inverse propensity score weighting, can be used to produce unbiased estimates of results by removing sampling bias from data.

In another aspect, multinomial weights can be used to un-bias the exploration data for when retraining the model. The multinomial weighting scheme is based on the scores of the baseline ranking model. Let xᵢ be the result displayed to the user from bucket Pi and let its ranking score be sᵢ. If xⱼ is the selected example for exploration, then we first compute the “multinomial probability”:

$$p ( {x}_{j} ) = \frac{{s}_{j}}{Σ i ∈ ( {c}_{1} , … , {c}_{l} )} \qquad Equation 1$$

The weight is then computed again as the inverse proportional wⱼ=1/(p(xⱼ)). If, in Table 3, we have selected for exploration the example at position i=3, then its probability is 0.6/(0.6+0.45+0.40)=0.6/1.45 and the weight is 1.45/0.6=2.41. We call this weighting scheme multinomial weighting.

The exploration simulator 242 can output data that can be used to evaluate different exploration policies. In one aspect, the exploration simulator 242 can rank evaluated policies according to simulated effectiveness and cost. The effectiveness measures the improvements to the ranking model that resulted from exploration, and the cost refers to a change in click-through rate during exploration. Some exploration policies may have improved click-through rate during exploration, which can be conceptualized as a negative cost, which would be a positive feature of an exploration policy.

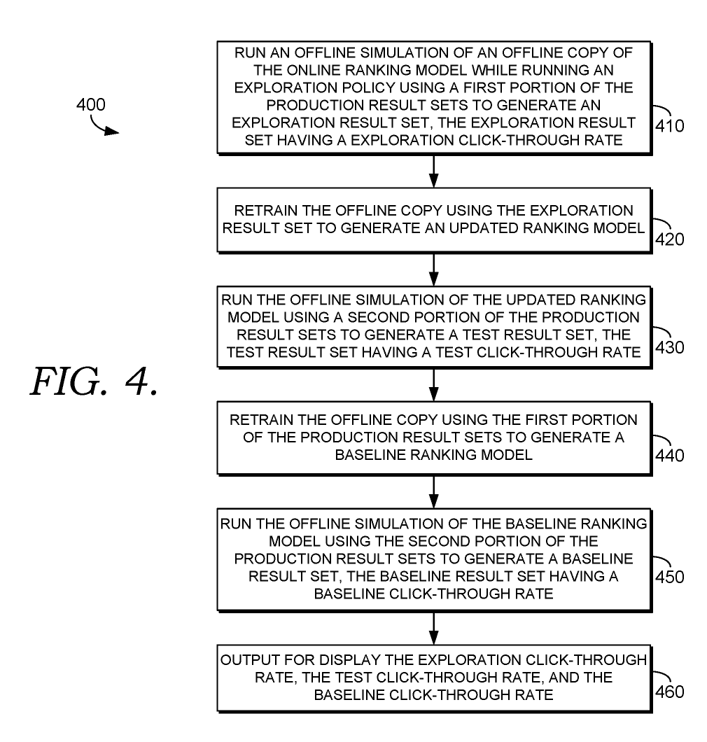

Turning now to FIG. 4, flow chart for a method 400 to evaluate exploration policies is provided, according to an aspect of the technology described herein. Method 400 could be performed by the exploration simulator 242, described previously.

At step 410, an offline simulation is run on an offline copy of the online ranking model while running an exploration policy using a first portion of the production result sets to generate an exploration result set. The logged production data can be split in two portions. The first portion can be used to simulate exploration and the second portion can be used to test the effectiveness of retrained models. The exploration result set has a click-through rate described herein as an exploration click-through rate because it represents the click-through rate during exploration. As mentioned, the cost of different exploration policies can be measured, in part, by a loss in click-through rate. Accordingly, the exploration click-through rate during implementation of different exploration polices is an important variable to consider when selecting exploration policies.

As explained previously, the simulation can replay production results according to a simulation policy. In one aspect, the first portion of data can comprise a month's worth of production results, which can be millions of results. The results can be filtered to determine a subset of results suitable for the simulation. For example, result sets with fewer than N results may be excluded. A certain percentage of the production result sets are designated for exploration. The exact results selected can be based on the setup of the exploration policy. For example, the exploration policy may seek to perform exploration with results selected from different buckets or intervals. In other words, the exploration policy can select result sets having exploration results with a score in a desired bucket to achieve an overall distribution of exploration results.

The exploration result set in exploration click-through rate can be based on production result sets that did not involve exploration along with result sets where exploration occurred. This accurately depicts the results of exploration in an online environment. For example, if the production results used for simulation included 2 million result sets and 100,000 of the result sets were used for exploration, then the exploration click-through rate would be based on clicks received for the 100,000 exploration result sets and the 1.9 million non-exploration result sets. A baseline click-through rate would be for the same 2 million result sets with no exploration.

Because it is a simulation, each iteration assumes that less than all of the results actually shown in the online environment are shown to a user. So even a production result as designated in a simulation would have a click-through rate calculated based on whether the user selected one of the top k production results in the online environment. Accordingly, the simulated click-through rate could be much less than the actual online click-through rate. However, the goal is not to compare the actual click-through rate observed with a simulated rate. Instead, a simulated baseline rate is used to determine the effectiveness and cost of an individual exploration policy.

At step 420, the offline copy is retrained using the exploration result set to generate an updated ranking model. Again, the exploration result sets can include both production results and exploration results for the purpose of retraining. For example, if the first portion of production results included 2 million results and only 100,000 were used for exploration, then the retraining would be based on 1.9 million production results and 100,000 exploration results. As previously mentioned, the exploration data may be weighted as part of the retraining process.

At step 430, the offline simulation of the updated ranking model is run using a second portion of the production result sets to generate a test result set. The goal of this test is to determine the effectiveness of the exploration data to retrain the model. The test result set has a test click-through rate that is a measure of the model's improvement after training. In this step, the offline simulation is run without exploration. The CTR of the test result sets can be compared against the CTR of test result sets generated by simulating other exploration policies or a baseline to determine which exploration policy gathered data that provides the greatest improvement in model performance.

At step 440, the offline copy is retrained using the first portion of the production result sets to generate a baseline ranking model. The first portion of the production result sets represents the model performance when no exploration is implemented. Even when no exploration is ongoing, the results can be used to retrain the online model and improve its accuracy. As mentioned previously, the production result sets can be adjusted to be comparable to the exploration result sets. For example, if the exploration result set is generated based on a simulated display of the top two or three results to the user, then the production results would simulate the display of the same two or three results without exploration.

At step 450, the offline simulation of the baseline ranking model is run using the second portion of the production result sets to generate a baseline result set. The baseline result set has a baseline click-through rate. The baseline click-through rate can be compared to the test click-through rate to determine whether retraining the model using the exploration data improved the click-through rate more than retraining the model on the baseline production data, which did not include exploration.

At step 460, the exploration click-through rate, the test click-through rate, and the baseline click-through rate are output for display. Once output, a user can compare the performance improvement produced by the exploration policy by comparing the test click-through rate with the baseline click-through rate. The cost of the exploration can be measured by looking at the exploration click-through rate. As mentioned, some exploration can result in a benefit rather than a cost. In other words, the exploration click-through rate is higher than the baseline click-through rate.

The simulated exploration click-through rate for different exploration policies can be evaluated to select an online exploration policy with an acceptable “cost.” Similarly, each simulated exploration policy generates exploration result sets that can be used to retrain the model. The retrained models can then be tested using a second portion of the result sets to determine which exploration sets provided larger model improvements. The model improvements associated with each result set can be compared to the “cost” of exploration to select an exploration policy.

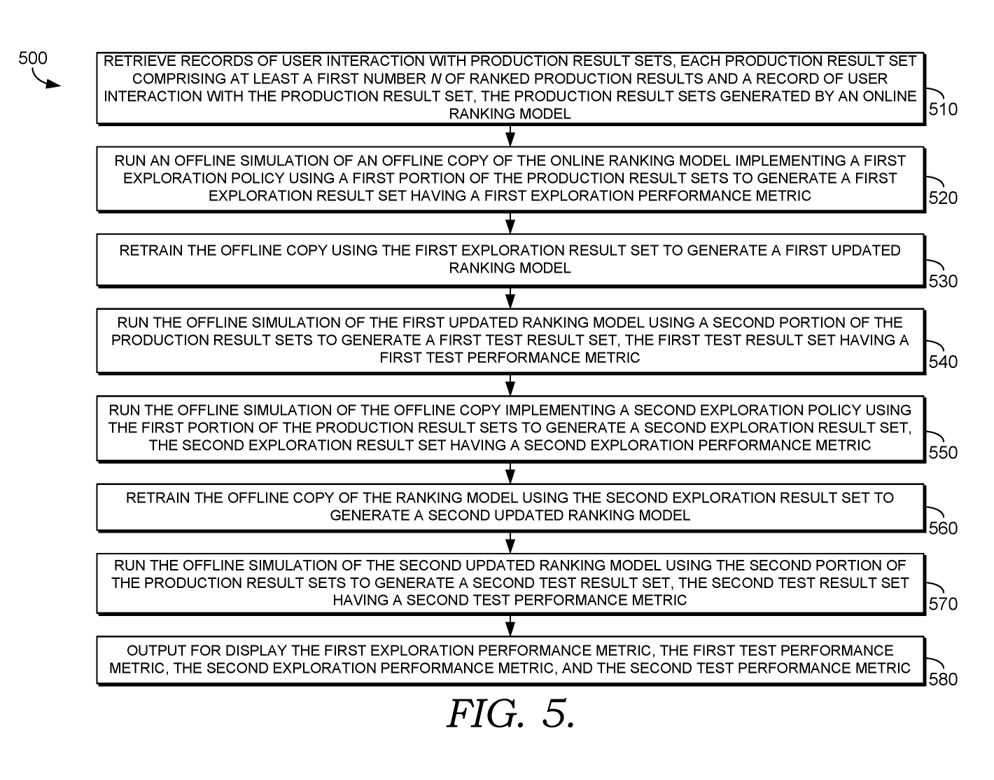

Turning now to FIG. 5, a method 500 of simulating an explore-exploit policy for improving a multi-result ranking system is provided, according to an aspect of the technology described herein. Method 500 could be performed by the exploration simulator 242, described previously.

At step 510, records of user interaction with production result sets are retrieved. The logged production result sets can be split in two portions. The first portion of the result sets can be used to simulate exploration and the second portion can be used to test the effectiveness of a retrained model. Each production result set comprises at least a first number N of ranked production results and a record of user interaction with each production result set. The user interaction can include selecting or hovering over a displayed result. The user interaction can also include not selecting any of the results. The user interaction data can be used to calculate a performance metric, such as a user engagement measure. The user interaction can include data that records user actions after selecting results, such as making purchase website linked to a search result. Such data can be used to generate a performance metric based on revenue generated. The production result sets are generated by an online ranking model in response to a user input, such as a query or partial query (as in FIG. 3). In this usage, “online” means in production and responding to real user input. The model could run entirely on a client device and “online” does not need to mean that the user is communicating over an Internet connection, though such communications occur in some aspects.

At step 520, an offline simulation of an offline copy of the online ranking model implementing a first exploration policy is run using a first portion of the production result sets to generate a first exploration result set having a first exploration performance metric. As explained previously, the simulation can replay production results according to a simulation policy. In one aspect, the first portion of data can comprise a month's worth of production results, which can be millions of results. The performance metric can be click-through rate, a user interaction metric based on more than just clicks (e.g. dwell time, hovers, gaze detection), and a revenue measure. The revenue measure can be calculated when the multi-result ranking model returns ads or other objects that can generate revenue when displayed, clicked, or when conversion occurs (e.g., the user makes a purchase or signs up on a linked website). The results can be filtered to determine a subset of results suitable for the simulation. For example, result sets with fewer than N results may be excluded. A certain percentage of the production result sets are designated for exploration. The exact results selected can be based on the setup of the exploration policy. For example, the exploration policy may seek to perform exploration with results selected from different buckets or intervals. In other words, the exploration policy can select result sets having exploration results with a score in a desired bucket to achieve an overall distribution of exploration results.

The exploration result set and exploration performance metric can be based on production result sets that did not involve exploration along with result sets where exploration occurred. This accurately depicts the results of exploration in an online environment. For example, if the production results used for simulation included 2 million result sets and 100,000 of the result sets were used for exploration, then the exploration performance metric would be based on user data received for the 100,000 exploration result sets and the 1.9 million non-exploration result sets. A baseline performance metric would be for the same 2 million result sets with no exploration.

Because it is a simulation, each iteration assumes that less than all of the results actually shown in the online environment are shown to a user. So even a production result as designated in a simulation would have a performance metric calculated based on whether the user selected one of the top k production results in the online environment. Accordingly, the simulated performance metric could be much less than the actual online performance metric. However, the goal is not to compare the actual click through rate observed with a simulated rate. Instead, a simulated baseline rate is used to determine the effectiveness and cost of an individual exploration policy.

At step 530, the offline copy is retrained using the first exploration result set to generate a first updated ranking model. Again, the exploration result sets can include both production results and exploration results for the purpose of retraining. For example, if the first portion of production results included 2 million results and only 100,000 were used for exploration, then the retraining would be based on 1.9 million production results and 100,000 exploration results. As previously mentioned, the exploration data may be weighted as part of the retraining process.

At step 540, the offline simulation of the first updated ranking model is run using a second portion of the production result sets to generate a first test result set. The first test result set has a first test performance metric. The goal of this test is to determine the effectiveness of the exploration data to retrain the model. The test result set has a test performance metric that is a measure of the model's improvement after training. In this step, the offline simulation is run without exploration. The CTR of the test result sets can be compared against the CTR of test result sets generated by simulating other exploration policies or a baseline to determine which exploration policy gathered data that provides the greatest improvement in model performance.

At step 550, the offline simulation of the offline copy implementing a second exploration policy is run using the first portion of the production result sets to generate a second exploration result set. The second exploration result set has a second exploration performance metric. The second exploration differs from the first exploration policy in some way. For example, the percentage of opportunities used for exploration may differ. In another aspect, the interval or buckets can be different, as described with reference FIG. 2.

At step 560, the offline copy of the ranking model is retrained using the second exploration result set to generate a second updated ranking model. The retraining at step 560 starts with the same model that was retrained in step 530. When comparing two different exploration policies, retraining the models starts at the same point so a side-by-side comparison can be made.

At step 570, the offline simulation of the second updated ranking model is run using the second portion of the production result sets to generate a second test result set. The second test result set has a second test performance metric.

At step 580, the first exploration performance metric, the first test performance metric, the second exploration performance metric, and the second test performance metric are output for display. The simulated exploration performance metrics for different exploration policies can be evaluated against each other and the baseline performance metric to select an online exploration policy with an acceptable “cost.” Similarly, each simulated exploration policy generates exploration result sets that can be used to retrain the model. The retrained models can then be tested using a second portion of the result sets to determine which exploration sets provided larger model improvements. The model improvements associated with each result set can be compared to the “cost” of exploration to select an exploration policy.

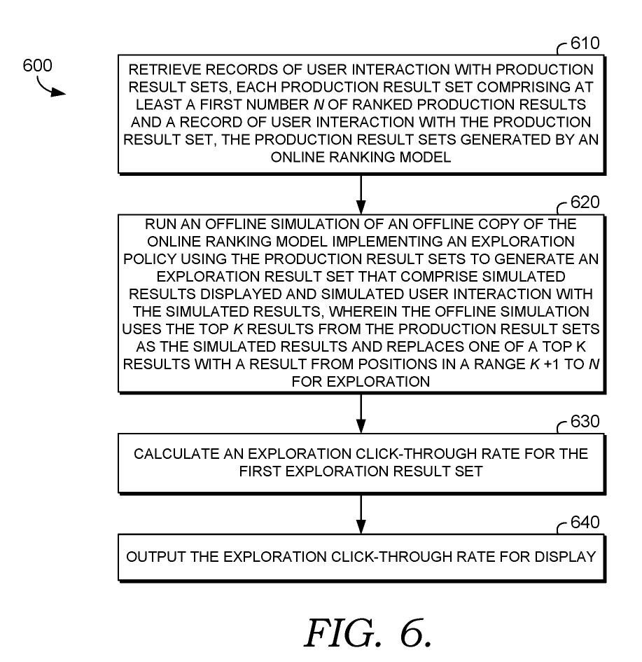

Turning now to FIG. 6, a method 600 of simulating an explore-exploit policy for improving a multi-result ranking system is provided, according to an aspect of the technology described herein. Method 600 could be performed by the exploration simulator 242, described previously.

At step 610, records of user interaction with production result sets are retrieved. Each production result set comprises at least a first number N of ranked production results and a record of user interaction with the production result set. The production result sets are generated by an online ranking model. The logged production data can be split in two portions. The first portion can be used to simulate exploration and the second portion can be used to test the effectiveness of retrained models.

At step 620, an offline simulation of an offline copy of the online ranking model implementing an exploration policy is run using the production result sets to generate an exploration result set that comprises simulated results displayed and simulated user interaction with the simulated results, wherein the offline simulation uses the top k results from the production result sets as the simulated results and replaces one of a top k results with a result from positions in a range k+1 to N for exploration. In one aspect, K can be selected as two or three values less than N.

At step 630, an exploration click-through rate for the exploration result set is calculated. The exploration result set in exploration click-through rate can be based on production result sets that did not involve exploration along with result sets where exploration occurred. This accurately depicts the results of exploration in an online environment. For example, if the production results used for simulation included 2 million result sets and 100,000 of the result sets were used for exploration, then the exploration click-through rate would be based on clicks received for the 100,000 exploration result sets and the 1.9 million non-exploration result sets. A baseline click-through rate would be for the same 2 million result sets with no exploration.

At step 640, the exploration click-through rate is output for display. The simulated exploration click-through rate for different exploration policies can be evaluated to select an online exploration policy with an acceptable “cost.” Similarly, each simulated exploration policy generates exploration result sets that can be used to retrain the model. The retrained models can then be tested using a second portion of the result sets to determine which exploration sets provided larger model improvements. The model improvements associated with each result set can be compared to the “cost” of exploration to select an exploration policy.

### Exemplary Operating Environment

Referring to the drawings in general, and initially to FIG. 7 in particular, an exemplary operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.” The computing device 700 may be a PC, a tablet, a smartphone, virtual reality headwear, augmented reality headwear, a game console, and such.

Computing device 700 typically includes a variety of computer-readable media. Computer-readable media can be any available media that can be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, vibrating component, etc. I/O ports 718 allow computing device 700 to be logically coupled to other devices, including I/O components 720, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separate from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

The computing device 700 may include a radio 724. The radio transmits and receives radio communications. The computing device 700 may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A computing system comprising:
at least one processor;
a data store comprising records of user interaction with production result sets, each production result set comprising at least a first number N of ranked production results and a record of user interaction with the production result set, the ranked production results generated by an online ranking model; and
memory having computer-executable instructions stored thereon that, based on execution by the at least one processor, configure the computing system to improve exploration policies by being configured to:
run an offline simulation of an offline copy of the online ranking model while running an exploration policy using a first portion of the production result sets to generate an exploration result set, the exploration result set having an exploration click-through rate;
retrain the offline copy using the exploration result set to generate an updated ranking model;
run the offline simulation of the updated ranking model using a second portion of the production result sets to generate a test result set, the test result set having a test click-through rate;
retrain the offline copy using the first portion of the production result sets to generate a baseline ranking model;
run the offline simulation of the baseline ranking model using the second portion of the production result sets to generate a baseline result set, the baseline result set having a baseline click-through rate; and
output for display the exploration click-through rate, the test click-through rate, and the baseline click-through rate.

2. The computing system of claim 1, wherein the offline simulation simulates display of k results from the production result sets, wherein k is less than N.

3. The computing system of claim 2, wherein the offline simulation uses results from positions in a range k+1 to N for exploration by replacing a result in a k position.

4. The computing system of claim 1, wherein the offline simulation specifies a test interval for sampling according to a relevance score assigned to an exploration result by the online ranking model.

5. The computing system of claim 1, wherein the offline simulation specifies a test interval for sampling according to a relevance score assigned to an exploration result by the online ranking model and a position in which the exploration result is displayed within a result set.

6. The computing system of claim 1, wherein the offline simulation specifies a test interval for sampling according to a position in which an exploration result is displayed within a result set.

7. The computing system of claim 1, wherein the first portion of the production result sets are from a period of time and the second portion of the production result sets from a second period of time.

8. A method of simulating an explore-exploit policy for a multi-result ranking system comprising:
retrieving records of user interaction with production result sets, each production result set comprising at least a first number N of ranked production results and a record of user interaction with the production result set, the production result sets generated by an online ranking model;
running an offline simulation of an offline copy of the online ranking model implementing a first exploration policy using a first portion of the production result sets to generate a first exploration result set having a first exploration performance metric;
retraining the offline copy using the first exploration result set to generate a first updated ranking model;
running the offline simulation of the first updated ranking model using a second portion of the production result sets to generate a first test result set, the first test result set having a first test performance metric;
running the offline simulation of the offline copy implementing a second exploration policy using the first portion of the production result sets to generate a second exploration result set, the second exploration result set having a second exploration performance metric;
retraining the offline copy of the ranking model using the second exploration result set to generate a second updated ranking model;
running the offline simulation of the second updated ranking model using the second portion of the production result sets to generate a second test result set, the second test result set having a second test performance metric; and
outputting for display the first exploration performance metric, the first test performance metric, the second exploration performance metric, and the second test performance metric.

9. The method of claim 8, wherein the offline simulation simulates display of k results from the production result sets, wherein k is less than N.

10. The method of claim 9, wherein the offline simulation uses results from positions in a range k+1 to N for exploration by replacing a result in a k position.

11. The method of claim 9, wherein the offline simulation uses results from positions in a range k+1 to N for exploration by replacing a result in a k−1 position.

12. The method of claim 8, wherein the offline simulation specifies a test interval for sampling according to a relevance score assigned to an exploration result by the online ranking model.

13. The method of claim 8, wherein the offline simulation specifies a test interval for sampling according to a score assigned to an exploration result by the online ranking model and a position in which the exploration result is displayed within a result set.

14. The method of claim 8, wherein the offline simulation specifies a test interval for sampling according to a position in which an exploration result is displayed within a result set.

15. The method of claim 8, wherein the first portion of the production result sets are from a period of time and the second portion of the production result sets from a second period of time.

16. A method of simulating an explore-exploit policy for a multi-result ranking system comprising:
retrieving records of user interaction with production result sets, each production result set comprising at least a first number N of ranked production results and a record of user interaction with the production result set, the production result sets generated by an online ranking model;
running an offline simulation of an offline copy of the online ranking model implementing an exploration policy using the production result sets to generate an exploration result set that comprises simulated results displayed and simulated user interaction with the simulated results, wherein the offline simulation uses the top k results from the production result sets as the simulated results and replaces one of a top k results with a result from positions in a range k+1 to N for exploration;
calculating an exploration click-through rate for the exploration result set; and
outputting the exploration click-through rate for display.

17. The method of claim 16, wherein the method further comprises:
retraining an offline version of the ranking model using the exploration result set to generate an updated ranking model;
running an offline simulation of the updated ranking model using a second portion of the production result sets to generate a test result set having a test click-through rate;
retraining the offline version of the ranking model using a first portion of the production result sets to generate a baseline ranking model;
running an offline simulation of the baseline ranking model using the second portion of the production result sets to generate a baseline result set, the baseline result set having a baseline click-through rate; and
outputting for display the exploration click-through rate, the test click-through rate, and the baseline click-through rate.

18. The method of claim 16, further comprising rerunning each simulation at different sampling rates.

19. The method of claim 16, wherein the exploration policy uses Thompson sampling.

20. The method of claim 16, wherein the offline simulation specifies a test interval for sampling according to a score assigned to an exploration result by the online ranking model and a position in which the exploration result is displayed within a result set.
